(19) United States
(12) Patent Application Publication
(10) Pub. No.: US 2013/0210281 A1
(43) Pub. Date: Aug. 15, 2013

(54) ELECTRICAL CONNECTOR

(71) Applicants: Sheng-Yuan Huang, New Taipei (TW); Sheng-Nan Yu, New Taipei (TW); Chih-Hsien Chiang, New Taipei City (TW)

(72) Inventors: Sheng-Yuan Huang, New Taipei (TW); Sheng-Nan Yu, New Taipei (TW); Chih-Hsien Chiang, New Taipei City (TW)

(73) Assignee: CHENG UEI PRECISION INDUSTRY CO., LTD., New Taipei City (TW)

(21) Appl. No.: 13/369,587

(22) Filed: Feb. 9, 2012

(51) Int. Cl. H01R 27/02

(52) U.S. Cl. 439/638

(57) ABSTRACT

An electrical connector includes an insulating housing defining a plurality of terminal grooves of substantial U-shape, and a plurality of electrical terminals of which each has a contact arm, a positioning body of a substantially inverted-U shape and a connecting arm connected between two bottom ends of the contact arm and one arm of the positioning body. The electrical terminal is assembled upward in the terminal groove. The contact arm and the one arm of the positioning body incline towards each other to make tops thereof project out of the terminal groove for clamping a mating terminal of a mating connector therebetween. A top sidewall of the terminal groove corresponding to the contact arm is inclined downward from outside to inside to be designated as a blocking wall which is located above the contact arm to restrict the contact arm in the terminal groove.

### BACKGROUND OF THE INVENTION

1. Field of the Invention

The present invention relates to an electrical connector, and more particularly to an electrical connector capable of firmly holding electrical terminals thereof and preventing deformation of the electrical terminals.

2. The Related Art

In the electronic industry, an electrical connector is adapted for connecting with a mating connector to realize an electrical connection between two different printed circuit boards. The electrical connector includes an insulating housing and a plurality of electrical terminals assembled in the insulating housing and each having a contact portion. The mating connector includes a mating housing and a plurality of mating terminals assembled in the mating housing and each having a contact arm. When the electrical connector is mated with the mating connector, the contact portions electrically contact the corresponding contact arms to make the electrical terminals and the corresponding mating terminals electrically interconnected. However, each of the electrical terminals contacts the respective mating terminal merely in one single point. As a result, when the assembly of the electrical connector and the mating connector is shaken in use, the contact portion is apt to depart from the corresponding contact arm that makes signal transmission between the electrical terminal and the corresponding mating terminal broken easily. Furthermore, the electrical terminals are apt to be hauled out of the insulating housing under the action of repeatedly inserting and extracting the mating terminals with respect to the electrical terminals so that even may deform the electrical terminals.

### SUMMARY OF THE INVENTION

Accordingly, an object of the present invention is to provide an electrical connector adapted for connecting with a mating connector which has an inserting chamber and a plurality of mating terminals mounted to two opposite lateral walls of the inserting chamber respectively. The electrical connector includes an insulating housing and a plurality of electrical terminals. The insulating housing has an inserting space of a substantially rectangular ring shape. Accordingly, a bottom wall, two side walls and two end walls are formed around the inserting space, and an inserting wall is formed in the middle of the inserting space. The insulating housing defines two rows of terminal grooves of substantial U-shape each opened across the bottom wall and two face-to-face inner sides of the inserting wall and the corresponding side wall. Each of the electrical terminals has a contact arm, a positioning body of a substantially inverted-U shape and a connecting arm connected between two bottom ends of the contact arm and one arm of the positioning body. The other arm of the positioning body is far away from and opposite to the contact arm, and a free end thereof bends sideward to form a soldering tail. The electrical terminal is assembled upward in the terminal groove with the connecting arm fastened in the bottom wall, the positioning body positioned in the corresponding side wall and the contact arm located in the inserting wall. The contact arm and the one arm of the positioning body incline towards each other to make tops thereof project out of the terminal groove and into the inserting space. The soldering tail stretches outside the corresponding side wall. When the electrical connector is connected with the mating connector, the inserting wall is inserted in the inserting chamber to clamp each of the mating terminals between the tops of the contact arm and the one arm of the positioning body of the corresponding electrical terminal. The terminal groove opened in the inserting wall has a top sidewall thereof inclined downward from outside to inside in accordance with the contact arm to be designated as a blocking wall. The blocking wall is located above the contact arm to restrict the contact arm in the terminal groove in the process of extracting the mating terminal out of the corresponding electrical terminal.

As described above, the mating terminal is clamped between the contact arm and the one arm of the positioning body of the corresponding electrical terminal so that ensures a steady electrical connection between the mating terminal and the corresponding electrical terminal. Furthermore, the blocking wall blocks above the contact arm to restrict the contact arm in the terminal groove so as to prevent the electrical terminal from being hauled out of the insulting housing and further avoid the deformation of the electrical terminal, without being affected by repeated insertion and extraction of the mating terminal and shaking of the assembly of the electrical connector and the mating connector.

### BRIEF DESCRIPTION OF THE DRAWINGS

The present invention will be apparent to those skilled in the art by reading the following description thereof, with reference to the attached drawings, in which:

FIG. 1 is a perspective view showing that an electrical connector in accordance with an embodiment of the present invention is disconnected from a mating connector;

FIG. 2 is a perspective view showing that the electrical connector of FIG. 1 is connected with the mating connector;

FIG. 3 is a perspective view of an electrical terminal of the electrical connector of FIG. 1;

FIG. 4 is a sectional view of the electrical connector of FIG. 1; and

FIG. 5 is a view showing a mating process of connecting a mating terminal of the mating connector with the corresponding electrical terminal of the electrical connector.

### DETAILED DESCRIPTION OF THE EMBODIMENT

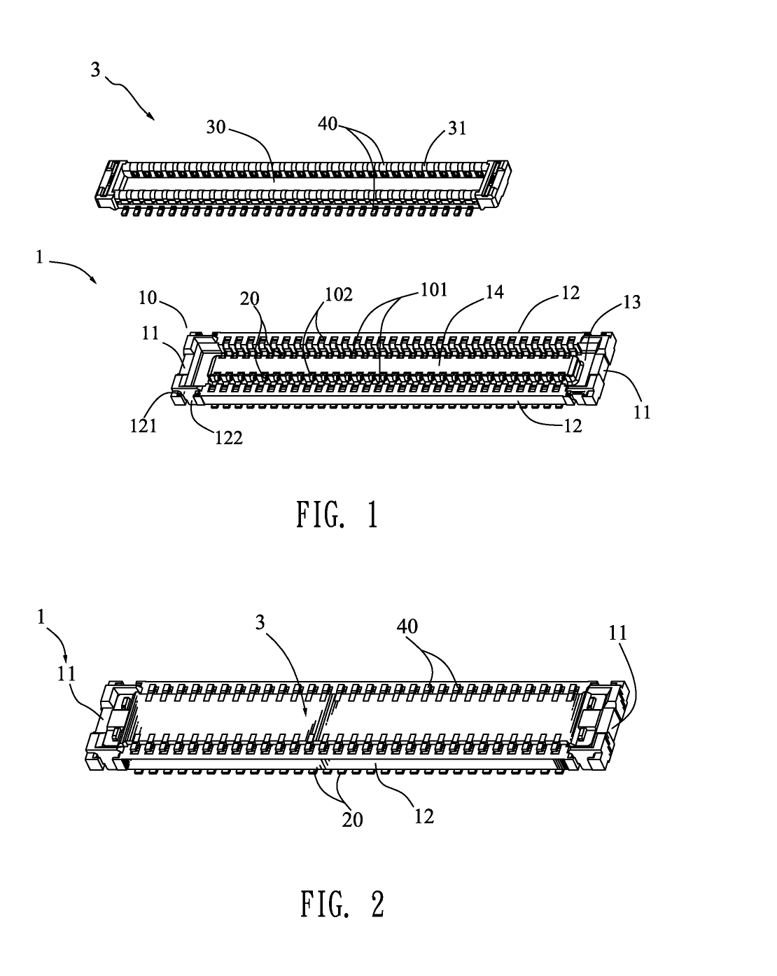

Referring to FIG. 1 and FIG. 2, an electrical connector 1 in accordance with an embodiment of the present invention is adapted for connecting with a mating connector 3 which has an inserting chamber 30 and a plurality of mating terminals 40 mounted to two opposite lateral walls 31 of the inserting chamber 30 respectively. The electrical connector 1 includes an insulating housing 10 and a plurality of electrical terminals 20 assembled in the insulating housing 10.

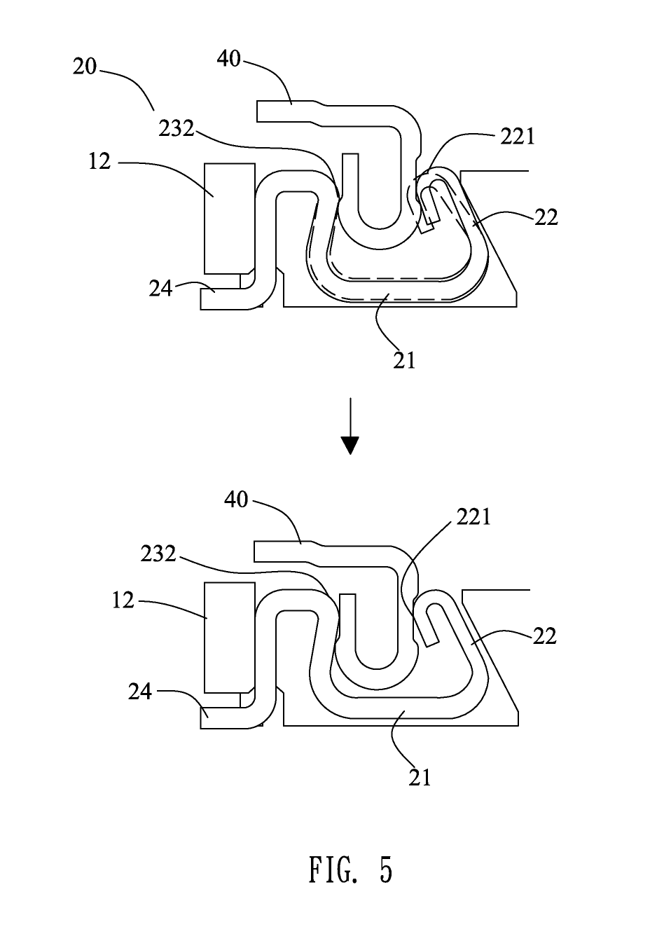

With reference to FIG. 1 and FIGS. 3-5, the insulating housing 10 has an inserting space 101 of a substantially rectangular ring shape. Accordingly, a bottom wall 13, two side walls 12 and two end walls 11 are formed around the inserting space 101, and an inserting wall 14 is formed in the middle of the inserting space 101. The insulating housing 10 defines two rows of terminal grooves 102 of substantial U-shape each opened across the bottom wall 13 and two face-to-face inner sides of the inserting wall 14 and the corresponding side wall 12.

Each of the electrical terminals 20 has a contact arm 22, a positioning body 23 of a substantially inverted-U shape and a connecting arm 21 connected between two bottom ends of the contact arm 22 and one arm of the positioning body 23. The other arm of the positioning body 23 is far away from and opposite to the contact arm 22, and a free end thereof bends sideward to form a soldering tail 24. The electrical terminal 20 is assembled upward in the terminal groove 102 with the connecting arm 21 fastened in the bottom wall 13, the positioning body 23 positioned in the corresponding side wall 12 and the contact arm 22 located in the inserting wall 14. The contact arm 22 and the one arm of the positioning body 23 incline towards each other to make tops thereof project out of the terminal groove 102 and into the inserting space 101. The soldering tail 24 stretches outside the corresponding side wall 12.

When the electrical connector 1 is connected with the mating connector 3, the inserting wall 14 is inserted in the inserting chamber 30 to clamp each of the mating terminals 40 between the tops of the contact arm 22 and the one arm of the positioning body 23 of the corresponding electrical terminal 20. The terminal groove 102 opened in the inserting wall 14 has a top sidewall thereof inclined downward from outside to inside in accordance with the contact arm 22 to be designated as a blocking wall 141. The blocking wall 141 is located above the contact arm 22 to restrict the contact arm 22 in the terminal groove 102 in the process of extracting the mating terminal 40 out of the corresponding electrical terminal 20.

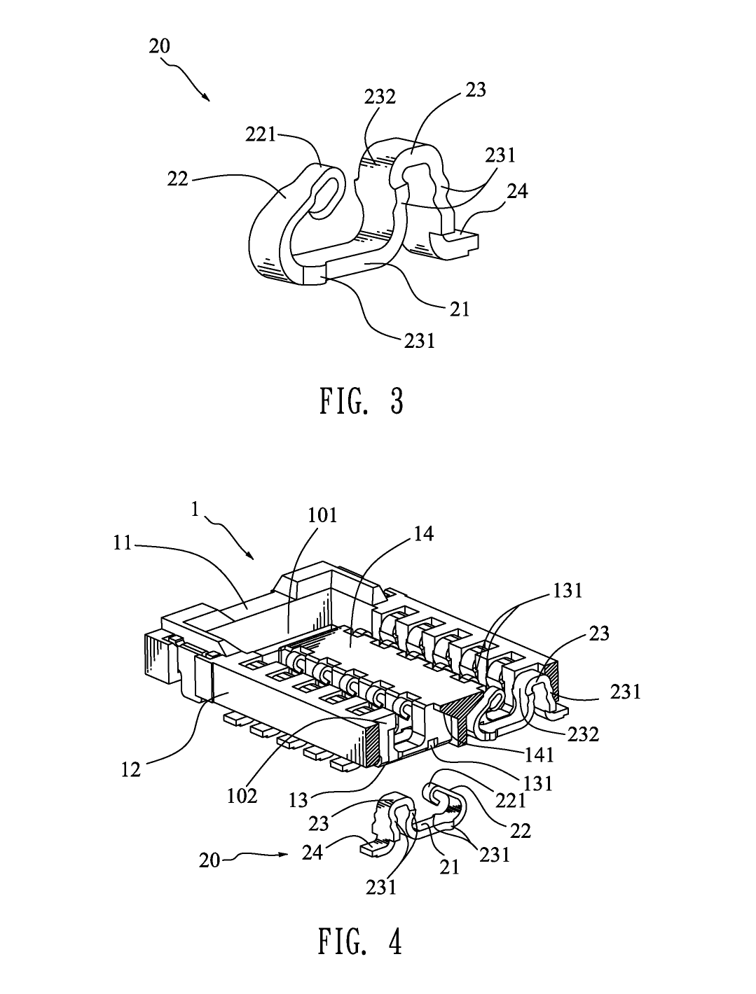

Referring to FIGS. 3-5 again, the top of the contact arm 22 bends inward and towards the contact arm 22 to form a first contact portion 221. The top of the one arm of the positioning body 23 is of an arched shape and acted as a second contact portion 232. The mating terminal 40 of the mating connector 3 is inserted between the contact arm 22 and the one arm of the positioning body 23 of the corresponding electrical terminal 20 with the first contact portion 221 and the second contact portion 232 abutting against two opposite outer sides of the mating terminal 40. The terminal groove 102 opened in the bottom wall 13 and the side wall 12 is oppositely concaved inward to form a plurality of fastening fillisters 131. Two opposite side edges of the connecting arm 21 and the positioning body 23 of the electrical terminal 20 oppositely protrude sideward to form a plurality of fastening ears 231 fastened in the fastening fillisters 131 respectively so as to firmly hold the electrical terminal 20 in the terminal groove 102 in the process of extracting the mating terminal 40 out of the corresponding electrical terminal 20. In the embodiment, the fastening ears 231 formed at the connecting arm 21 are protruded near to the contact arm 22.

Referring to FIG. 1 and FIG. 4, two ends of each side wall 12 of the insulating housing 10 respectively define an inserting slot 121 vertically penetrating therethrough for inserting a fastening slice 122 therein.

As described above, the mating terminal 40 is clamped between the contact arm 22 and the one arm of the positioning body 23 of the corresponding electrical terminal 20 to make the contact portions 221, 232 elastically abut against the two opposite outer sides of the mating terminal 40 so that ensures a steady electrical connection between the mating terminal 40 and the corresponding electrical terminal 20. Furthermore, the fastening ears 231 are buckled in the fastening fillisters 131 respectively and the blocking wall 141 blocks above the contact arm 22, so that can firmly hold the electrical terminal 20 in the corresponding terminal groove 102 to prevent the electrical terminal 20 from being hauled out of the insulting housing 10 and further avoid the deformation of the electrical terminal 20, without being affected by repeated insertion and extraction of the mating terminal 40 and shaking of the assembly of the electrical connector 1 and the mating connector 3.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An electrical connector adapted for connecting with a mating connector which has an inserting chamber and a plurality of mating terminals mounted to two opposite lateral walls of the inserting chamber respectively, the electrical connector comprising:
an insulating housing having an inserting space of a substantially rectangular ring shape, accordingly, a bottom wall, two side walls and two end walls being formed around the inserting space, and an inserting wall being formed in the middle of the inserting space, the insulating housing defining two rows of terminal grooves of substantial U-shape each opened across the bottom wall and two face-to-face inner sides of the inserting wall and the corresponding side wall; and
a plurality of electrical terminals of which each has a contact arm, a positioning body of a substantially inverted-U shape and a connecting arm connected between two bottom ends of the contact arm and one arm of the positioning body, the other arm of the positioning body being far away from and opposite to the contact arm, and a free end thereof bending sideward to form a soldering tail, the electrical terminal being assembled upward in the terminal groove with the connecting arm fastened in the bottom wall, the positioning body positioned in the corresponding side wall and the contact arm located in the inserting wall, the contact arm and the one arm of the positioning body inclining towards each other to make tops thereof project out of the terminal groove and into the inserting space, the soldering tail stretching outside the corresponding side wall,
wherein when the electrical connector is connected with the mating connector, the inserting wall is inserted in the inserting chamber to clamp each of the mating terminals between the tops of the contact arm and the one arm of the positioning body of the corresponding electrical terminal, the terminal groove opened in the inserting wall has a top sidewall thereof inclined downward from outside to inside in accordance with the contact arm to be designated as a blocking wall, the blocking wall is located above the contact arm to restrict the contact arm in the terminal groove in the process of extracting the mating terminal out of the corresponding electrical terminal.

2. The electrical connector as claimed in claim 1, wherein the top of the contact arm bends inward and towards the contact arm to form a first contact portion, the top of the one arm of the positioning body is of an arched shape and acted as a second contact portion, the mating terminal of the mating connector is inserted between the contact arm and the one arm of the positioning body of the corresponding electrical terminal with the first contact portion and the second contact portion abutting against two opposite outer sides of the mating terminal.

3. The electrical connector as claimed in claim 2, wherein the terminal groove opened in the bottom wall and the side wall is oppositely concaved inward to form a plurality of fastening fillisters, two opposite side edges of the connecting arm and the positioning body of the electrical terminal oppositely protrude sideward to form a plurality of fastening ears fastened in the fastening fillisters respectively so as to firmly hold the electrical terminal in the terminal groove in the process of extracting the mating terminal out of the corresponding electrical terminal.

4. The electrical connector as claimed in claim 3, wherein the fastening ears formed at the connecting arm are protruded near to the contact arm.

5. The electrical connector as claimed in claim 1, wherein two ends of each side wall of the insulating housing respectively define an inserting slot vertically penetrating therethrough for inserting a fastening slice therein.
